(19) United States
(12) Patent Application Publication
(10) Pub. No.: US 2007/0038431 A1
(43) Pub. Date: Feb. 15, 2007

(54) Data processing apparatus simulation

(75) Inventors: Simon Yoon, Yorba Linda, CA (US); Chulho Shin, Rancho Santa Margarita, CA (US)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/202,363

(22) Filed: Aug. 12, 2005

(51) Int. Cl. G06F 17/50

(52) U.S. Cl. 703/17

(57) ABSTRACT

A method, system and computer programs for simulating the operation of a data processing apparatus when executing a sequence of instructions is disclosed. The data processing apparatus comprising a plurality of units, each of the units having associated therewith architectural state generated in response to the sequence of instructions. The method comprises the steps of: providing a hardware description model comprising a hardware description component corresponding with at least one of the plurality of units, each hardware description component comprising a hardware characteristic component representing the hardware characteristics of that unit and an architectural state component for storing a representation of any architectural state associated with that unit generated in response to the sequence of instructions; providing a system level model comprising a system level component corresponding with at least one other of the plurality of units, the system level model further comprising at least one shadow architectural state component for storing a representation of any architectural state stored by a corresponding architectural state component of the hardware description model; executing the hardware description model and the system level model to simulate the operation of the data processing apparatus when executing the sequence of instructions; and causing any changes in architectural state stored in the corresponding architectural state component to be also stored by the shadow architectural state component. Accordingly, the status of the architectural state can readily be determined in combination with information from the system level component using tools associated with the system level model. In this way, a correlation can readily be made between the status of the system level component and the architectural state generated by the hardware description model in response to the sequence of instructions. Also, by only causing the shadow architectural state component to store architectural state when architectural state within the architectural state component is updated, the number of updates between the hardware description model and the system level model can be minimized to only those which are required to provide a representation of the current state of the hardware description model. Reducing the number of updates required to be communicated between the two models significantly improves the performance of these models.

### FIELD OF THE INVENTION

The present invention relates to data processing apparatus simulation. Embodiments of the present invention relate to a method of simulating the operation of a data processing apparatus using both a hardware description model and a system level model.

### BACKGROUND OF THE INVENTION

In a development environment, it is often the case that the operation of a data processing apparatus needs to be characterised. Techniques for simulating the operation of a data processing apparatus to understand its operating characteristics are known. One such simulation technique uses a software model representative of the data processing apparatus. The software model typically models each component unit of the data processing apparatus. The software model can then be employed to examine the expected interactions of the component units of the data processing apparatus under different operating conditions.

It is known to model the operational behaviour of the data processing apparatus at different levels of abstraction. Modeling at different levels of abstraction provides various advantages and disadvantages. Typically, modeling at a high level of abstraction provides less information relating to the detailed operation of the data processing apparatus, but that model will typically execute relatively quickly. Modeling at a lower level of abstraction provides more information on the detailed operation of the data processing apparatus, but these models typically take much longer to execute.

In the development environment, it is often the case that the operation of a data processing apparatus needs to be characterised following the modification of an existing component unit or the introduction of a new component unit.

In these situations, a lower abstraction level model, such as an RTL model which may reflect a particular hardware implementation of the component unit, may be already available for component units of the data processing apparatus. However, such an RTL model may not yet be available for the new or modified component unit.

Accordingly, the new component unit will typically be initially modeled at the higher level of abstraction, such as a system level or transaction level model programmed in a language such as C. Once it is clear that the component unit will operate correctly, the RTL model may then be developed thereafter.

The two models together are arranged to co-simulate the operation of the data processing apparatus when responding to, for example, a predetermined sequence of instructions. Various standard techniques known in the art are used to enable the RTL model and the system level model to function correctly during co-simulation by providing mechanisms to enable relevant information required by one model from the other to be passed between them. These mechanisms, such as a translator interface, operate automatically whilst the co-simulation is being performed. In this way, the characteristics of the operation of the data processing apparatus in response to the sequence of instructions can be determined.

Tools are provided which enable the user to interact with the different models. For example, tools, such as debug tools, are provided which enable the user to obtain information from the system level model to determine the operation of that model in response to the sequence of instructions. Furthermore, tools are provided which enable the user to obtain information, such as architectural state information, from the RTL model to determine the operation of that model in response to the sequence of instructions.

However, it is difficult for the debug tools to obtain from the system level model helpful information relating to the architectural state of the data processing apparatus in response to the sequence of instructions. In particular, it is not possible to determine from the system level model itself any information relating to the status of any memory locations, the status of any registers, the logic levels asserted on any particular paths or any other architectural state information within the data processing apparatus.

Whilst all this information is theoretically available from the RTL model, the translator mechanism does not allow access to that information from the system level model when the models halt execution, such as would occur during debug. Hence, it is not easy to obtain a detailed understanding of the architectural state of the data processing apparatus in response to instructions using the tools associated with the system level model.

Also, whilst it is possible to gain an accurate understanding of the architectural state of the data processing apparatus using the tools associated with the RTL model, it is difficult to understand the relationship, if any, between any particular individual item of architectural state and any particular individual instruction.

Accordingly, a problem exists in that it is difficult to cross-correlate information from the two models in a meaningful manner. This restricts the ability of the user to determine the effects of the sequence of instructions on the operation of the data processing apparatus when using the co-simulation approach.

Whilst some techniques exists which seek to attempt to alleviate this problem, those approaches significantly impact on the performance of the models during co-simulation.

Accordingly, it is desired to provide an improved technique for simulating the operation of a data processing apparatus.

### SUMMARY OF THE INVENTION

According to a first aspect of the present invention there is provided a method of simulating the operation of a data processing apparatus when executing a sequence of instructions, the data processing apparatus comprising a plurality of units, each of the units having associated therewith architectural state generated in response to the sequence of instructions, the method comprising the steps of: providing a hardware description model comprising a hardware description component corresponding with at least one of the plurality of units, each hardware description component comprising a hardware characteristic component representing the hardware characteristics of that unit and an architectural state component for storing a representation of any architectural state associated with that unit generated in response to the sequence of instructions; providing a system level model comprising a system level component corresponding with at least one other of the plurality of units, the system level model further comprising at least one shadow architectural state component for storing a representation of any architectural state stored by a corresponding architectural state component of the hardware description model; executing the hardware description model and the system level model to simulate the operation of the data processing apparatus when executing the sequence of instructions; and causing any changes in architectural state stored in the corresponding architectural state component to be also stored by the shadow architectural state component.

The present invention recognises that one of the difficulties in understanding the operation of the data processing apparatus in response to the sequence of instruction is that it is difficult to obtain, using tools associated with the system level model, information relating to any architectural state within the hardware description model.

Accordingly, the system level model is provided with a shadow architectural state component. The shadow architectural state component stores some or all of the architectural state associated with one or more of the units modeled by the hardware description model. By providing this shadow architectural state component within the system level model, the status of this architectural state can readily be determined in combination with information from the system level component using tools associated with the system level model. In this way, a correlation can readily be made between the status of the system level component and the architectural state generated by the hardware description model in response to the sequence of instructions. This significantly improves the usefulness and ease of use of the models.

Also, by providing both an architectural state component for storing architectural state within the hardware description model and one or more shadow architectural state components for storing architectural state in the system level model, the performance of the hardware description level model will remain relatively unaltered since the architectural state information required by the hardware description level model is still accessible within the hardware description model domain.

Furthermore, by only causing the shadow architectural state component to store architectural state when architectural state within the architectural state component is updated, the number of updates between the hardware description model and the system level model can be minimized to only those which are required to provide a representation of the current state of the hardware description model. Reducing the number of updates required to be communicated between the two models significantly improves the performance of these models.

In one embodiment, the method further comprises the step of providing a software debugger operable to access the system level components and the at least one shadow architectural state component.

Accordingly, the software debugger, which is typically associated with the system level model, can readily access both the system level components and details of the architectural state within the hardware description model from the shadow architectural state component.

In one embodiment, the method further comprises the step of halting execution of the system level model and the hardware description model in response to a request from the software debugger.

Hence, even when the software debugger causes the operation of the models to cease, the both the system level components and the architectural state within the hardware description model will be available from the system level model.

In one embodiment, the method further comprises the step of accessing the system level components and the at least one shadow architectural state component to enable details of architectural state stored by the hardware description model to be determined by the software debugger.

Hence, the software debugger will still have direct access to both the system level components and the architectural state within the hardware description model despite the operation of these models being halted.

In one embodiment, the step of executing comprises co-simulating the system level model and the hardware description model.

In one embodiment, the step of causing comprises executing a function call from the hardware description model when the architectural state is updated.

Accordingly, only when the architectural state is updated is a function call made from the hardware description model to provide an indication of the update to that architectural state.

In one embodiment, the step of causing comprises executing a programming language interface function call from the model hardware description when the architectural state is altered.

Hence, the function call may take the form of a programming language interface function call from within the hardware description model.

In one embodiment, the at least one shadow architectural state component stores the representation of any architectural state updated in the corresponding architectural state component of the hardware description model in response to the programming language interface function call.

Hence, the system level model will cause the updated architectural state to be stored in the shadow architectural state component in response to the function call.

In one embodiment, each architectural state component stores a representation of storage provided by that unit.

It will be appreciated that the storage may comprise any number of different storage elements or storage items.

In one embodiment, the storage comprises at least one of memory regions and registers provided by that unit.

Accordingly, the storage may relate to one or more memory locations or regions, or to registers or even flags or other logic element which provides a storage capability.

In one embodiment, each architectural state component stores a representation of signal levels provided by that unit.

Hence, not only can architectural state relating to storage be provided but also the architectural state of individual paths, buses or logic units may also be provided.

In one embodiment, the system level model comprises a transaction level model.

Such transaction level models are sometimes referred to as electronic system level models.

In one embodiment, the system level model comprises a C programming language model.

In one embodiment, the hardware description model comprises an register transfer logic model.

According to a second aspect of the present invention there is provided a system for simulating the operation of a data processing apparatus when executing a sequence of instructions, the data processing apparatus comprising a plurality of units, each of the units having associated therewith architectural state generated in response to the sequence of instructions, the system comprising: a hardware description software model comprising a hardware description component corresponding with at least one of the plurality of units, each hardware description component comprising a hardware characteristic component operable to represent the hardware characteristics of that unit and an architectural state component operable to store a representation of any architectural state associated with that unit; a system level model comprising a system level component corresponding with at least one other of the plurality of units, the system level model further comprising at least one shadow architectural state component operable to store a representation of any architectural state stored by a corresponding architectural state component of the hardware description model, the hardware description model and the system level model being operable to simulate the operation of the data processing apparatus when executing the sequence of instructions and to cause any changes in architectural state generated in response to the sequence of instructions and stored in the corresponding architectural state component to be also stored by the shadow architectural state component.

According to a third aspect of the present invention there is provided a computer program for simulating the operation of a data processing apparatus when executing a sequence of instructions, the data processing apparatus comprising a plurality of units, each of the units having associated therewith architectural state generated in response to the sequence of instructions, the computer program comprising: a hardware description model comprising a hardware description component corresponding with at least one of the plurality of units, each hardware description component comprising a hardware characteristic component representing the hardware characteristics of that unit and an architectural state component for storing a representation of any architectural state associated with that unit generated in response to the sequence of instructions, the hardware description model being operable, when executed with a system level model comprising a system level component corresponding with at least one other of the plurality of units, to simulate the operation of the data processing apparatus when executing the sequence of instructions, the hardware description model being further operable to cause any changes in architectural state stored in the corresponding architectural state component to be also stored by a shadow architectural state component of the system level model.

According to a fourth aspect of the present invention there is provided a computer program for simulating the operation of a data processing apparatus when executing a sequence of instructions, the data processing apparatus comprising a plurality of units, each of the units having associated therewith architectural state generated in response to the sequence of instructions, the computer program comprising: a system level model comprising a system level component corresponding with at one of the plurality of units, the system level model further comprising at least one shadow architectural state component operable to store a representation of any architectural state stored by an architectural state component of a hardware description model, the system level model being operable, when executed with the hardware description model to simulate the operation of the data processing apparatus when executing the sequence of instructions, the system level model being further operable to store in the shadow architectural state component any changes in architectural state received from the hardware description model.

### BRIEF DESCRIPTION OF THE DRAWINGS

The present invention will be described further, by way of example only, with reference to preferred embodiments therefore as illustrated in the accompanying drawings in which:

FIG. 1 is a block diagram schematically illustrating a model for simulating the operation of a data processing apparatus according to one embodiment; and

FIG. 2 is a flow chart illustrating the operation of the model of FIG. 1.

### DESCRIPTION OF THE EMBODIMENTS

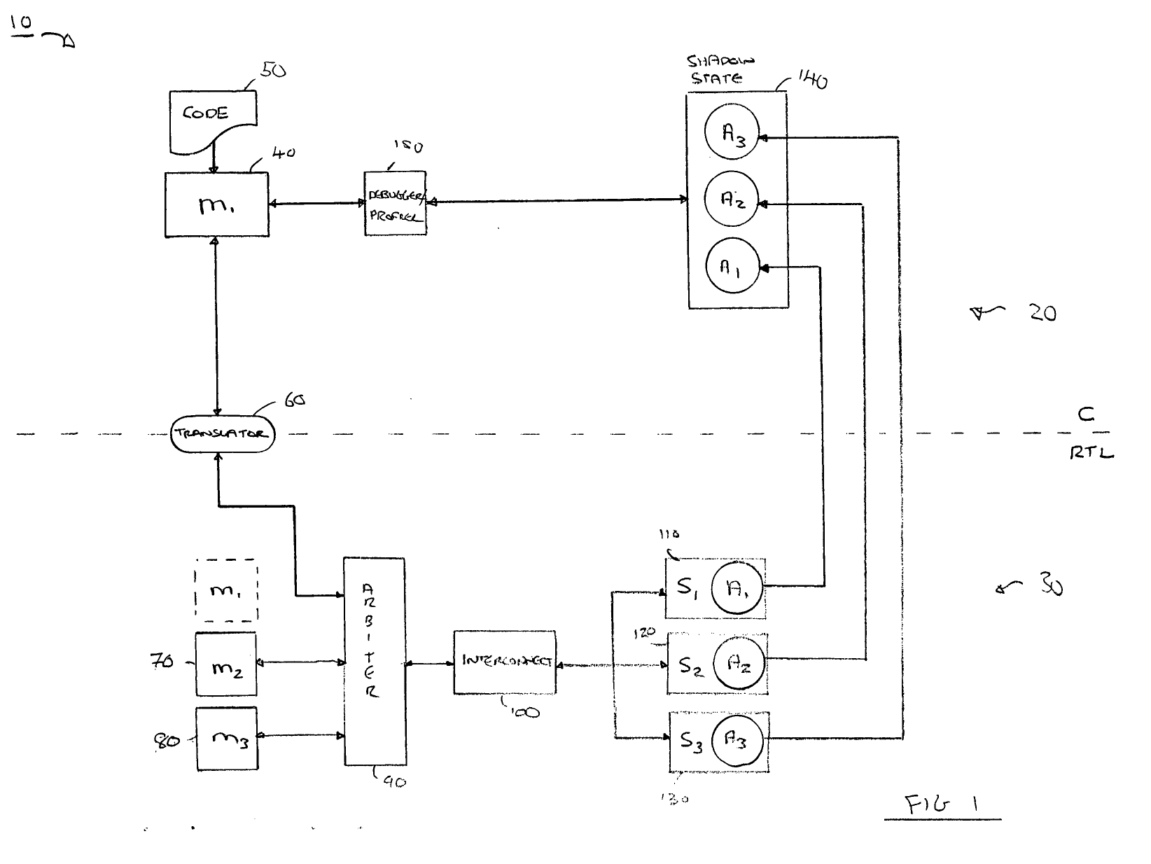

FIG. 1 illustrates a modeling system, generally 10, according to one embodiment.

As mentioned previously, in a typical data processing apparatus development scenario models are used to help characterise and refine the design and implementation of component units of that data processing system. Most component units are initially modeled at a higher level, for example using a system level model programmed using C and, once confidence is achieved in that design, each component unit is then modeled at a lower level, for example using a hardware description model programmed using register transfer logic (RTL). Accordingly, the modeling system 10 has a C environment 20 and an RTL environment 30.

Co-simulation of these two models helps smooth out the transition of each model from the high level simulation into RTL. Each new RTL model can be introduced and simulated along with the other models representing the other component units. During this transition phase, the verification emphasis is put on the RTL environment. It is the RTL model that is generally under test and it is important to capture all hardware events that surround the operation of that model. Accordingly, it is generally desirable to keep all architectural state information within the RTL environment 30 since this enables all RTL information to be present for verification and debugging purposes.

However, for efficient debugging it is critical to provide as much visibility as possible. Hardware visibility is provided by an RTL simulator (not shown) within the RTL environment 30 but it is also important to have debug visibility from the C environment 20 to be able to understand the correlation between hardware events and architectural state modeled within the RTL environment 30. This visibility extends to needing to provide, within the C environment, a software view using an external embedded software debugger (not shown) and a view of the architectural state contained in the RTL models. As will be discussed in more detail below, this is achieved by maintaining a mirrored, virtual or shadow state component 140 in the C environment 140.

The following describes an example arrangement of models co-simulating a data processing apparatus comprising a number of master units M1 to M3 coupled via an arbiter and interconnect with a number of slave units S1 to S3. However, it will be appreciated that the same techniques can be applied to other example arrangements. In this example, RTL models exist for all except the master unit M1, for which a system level model 40 is available. However, it will be appreciated that one or more other models may also be modeled in the C environment 20. Also, the following example assumes that, for debug purposes, only the memory regions associated with slave units S1 to S3 are of interest since the contents of these regions are also stored in the shadow state component 140 when updated. However, it will be appreciated that any other architectural state information associated with any of the RTL models could be provided to the shadow state component 140.

Accordingly, within the C environment 20 there is provided a system level model 40 of the component unit M₁ of the data processing apparatus which is being developed. The component unit M₁ may be a new or modified component unit of the data processing apparatus. The system level model 40 is generated using a Max Sim, which is a cycle-based SystemC simulation environment which utilises a cycle-based simulation engine (not shown). The system model 40 represents the characteristics of the component unit M1, as is known in the art. In this example, the component unit M1 represented by the system level model 40 is a processor core. However, it will be appreciated that the system level model 40 may represent any other unit or units of the data processing apparatus.

Software code 50 is also provided which contains example software code to be executed by the system level model 40 when investigating the characteristics of the simulated data processing apparatus. Whilst the software code 50 has been shown as interacting with the system level model 40 in the C environment 20, it will be appreciated that the software code 50 could instead be provided in the RTL environment 30, or a combination of the two.

Coupled with the system level model 40 is a translator 60 which is operable to receive any data provided by the system level model 40 which is required for by the models in the RTL environment 30. The translator 60 translate that data into a form suitable for use by models in the RTL environment 30. Equally, the translator 60 translates any data provided from the RTL environment 30 for use by the system level model 40 in the C environment 20. Such translators used during co-simulation are well known in the art.

The RTL environment 30 contains a number of RTL models 70 to 130 which model the remaining component units of the data processing apparatus. Each RTL model 70 to 130 generally contain two RTL components, a hardware RTL component and an architectural state RTL component. The hardware RTL component models the particular hardware characteristics of that component unit. The architectural state RTL component represents that current architectural state of that component unit. For example, in a RTL model of a memory system, the hardware RTL component of that model may represent the particular hardware arrangement of buses and any multiplexing arrangements, together with characteristics of the bit and word lines and even the characteristics of the cells within that memory system. Within the architectural state RTL component will be stored information indicating data stored within those memory cells, together with the state of those buses, multiplexers and any other lines or logic units. For example, the slave units S1 to S3 represented by the RTL models 110 to 130 have architectural state information A1 to A3 associated therewith. The other RTL models 70 to 100 also have architectural state information associated therewith. However, these have been omitted for reasons of clarity.

As already mentioned, within the C environment 20 there provided the shadow architectural state component 140 which is operable to store architectural state information provided from any of the RTL models 70 to 130. In this example arrangement, the shadow state component 140 stores architectural state information A1 to A3 which is associated with the RTL models 110 to 130 modeling the slave units S1 to S3. In particular, in this arrangement the shadow state component 140 stores state information from memory regions of interest which are associated with the slave units S1 to S3. However, it will be appreciated that the shadow state component 140 may store all or any subset of any of the architectural state information associated with any of the RTL models 70 to 130.

When it is determined which architectural state within the RTL models is of interest, those RTL models are annotated to include programming language interface (PLI) function calls which occur when the architectural state of interest is modified or updated. It will be appreciated that by only causing a PLI function call to be activated when the architectural state is modified, the number of PLI function calls which need to be made is minimized to only those which enable an accurate record of architectural state within the C environment 20 to be maintained. This provides significant performance benefits since the occurrence of such PLI function calls can degrade the performance of the RTL models.

Using PLI function calls to mirror architectural state from the RTL model to the shadow state component 140 enables a consistent view of the architectural state to be provided within both the RTL environment 30 and the C environment 20. Accordingly, an understanding of the architectural state can be fully obtained from within the C environment 20 and this obviates the need for either the system level model 40 to be written in RTL, or, conversely, for the RTL models 70 to 130 to be rewritten into C.

Accordingly, architectural state information required by the RTL model 70 to 130 remains within the RTL environment 30. This ensures that the execution speed of the RTL models is not overly altered since the information required by those models still remains within the RTL environment 30. However, all of the information required by the any tools within the C environment is provided by the shadow state component 140 which significantly increases the utility of those tools. Because updates to the shadow state component 140 by the RTL models only occurs when that state is changed (for example, an address region modeled in RTL is accessed and updated), the performance impact on the overall operation of the RTL model is minimized.

Within the C environment 20, there is provided various debugger and profiling tools, such as the MaxSim debug interface and the MaxSim profiling interface 150. The MaxSim debugging interface is a mechanism for providing components, system and software visibility to the user. When enabled, the MaxSim debug interface halts the co-simulation and enables non-intrusive, zero-delay accesses which probe items within the C environment 20 to retrieve information about architectural state or resources, this information is then displayed in MaxSim debug interface windows. Such information includes the state of registers and memory regions. For processors models, an external software debugger (such as ARM real view debugger, not shown) can be attached to provide software-centric visibility. Proving the shadow state component 140 overcomes the limitation that no debug accesses are allowed into the RTL environment 30 from the MaxSim debug interface and the MaxSim profiling interface 150 and, accordingly, those MaxSim debug interface and the MaxSim profiling interface 150 features can be realised for any models residing in the RTL environment 30. For example, MaxSim debug interface and the MaxSim profiling interface 150 can correlate information relating to the execution of the software code on the master unit M1, together with the effects of that code on the architectural state of the RTL model. It will be appreciated that this provides significant advantages.

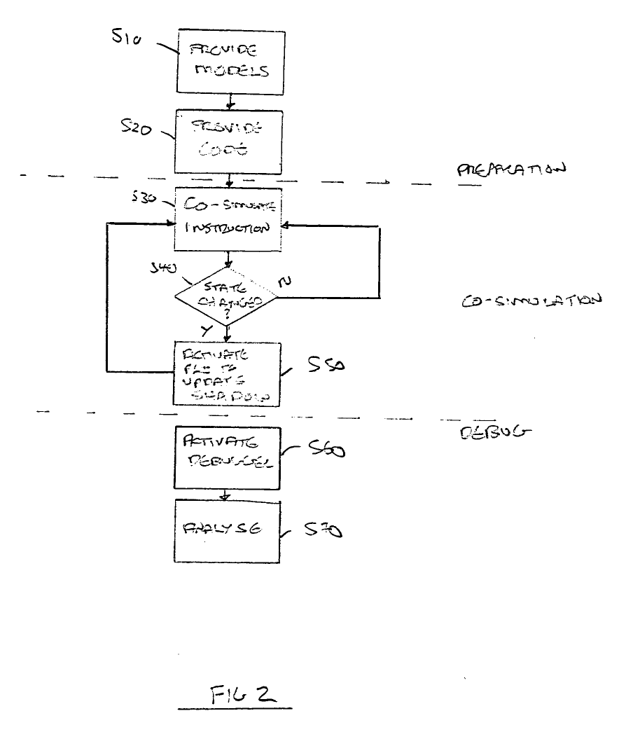

FIG. 2 is a flow diagram illustrating the operation of the modeling system 10 shown in FIG. 1.

During a preparation stage, at step S10, the system C and RTL models are provided.

Thereafter, at step S20, the code to be simulated is provided. This ends the preparation stage.

Thereafter, the co-simulation stage is entered. Accordingly, at step S30 an instruction within the code is co-simulated by the models.

At step S40, a determination is made by one or more of the RTL models of whether a PLI function call should be made because architectural state of interest has changed. It will be appreciated that this determination may be made automatically by the RTL models in situations where such PLI function calls have been provided within the model which should be activated should that architectural state change.

If no architectural state of interest has been modified, then processing proceeds to the step S30 where the next instruction is co-simulated.

In the event that it is determined that architectural state of interest has been altered, then processing proceeds to step S50 where a PLI function call is made which causes the shadow state component 140 to be updated with this change.

Thereafter, processing proceeds to step S30 where the next instruction is co-simulated.

This co-simulation phrase continues until either the code finishes execution or a debug or other external event occurs to halt the co-simulation.

Should a debug request occur then the debugger 150 will activate at step S60 and, at step S70, the MaxSim debug interface and the MaxSim profiling interface 150 will analyse information, such as that associated with the code 50, the system model 40 and the contents of the shadow state component 140 and provide that information in a manner required by the user.

Thereafter, the co-simulation may be re-initiated in which case processing will proceed to step S30. Alternatively, the models or code may be updated, in which case, processing will proceed to either step S10 or step S20.

Accordingly, the system level model is provided with a shadow architectural state component. The shadow architectural state component stores some or all of the architectural state associated with one or more of the units modeled by the hardware description model. By providing this shadow architectural state component within the system level model, the status of this architectural state can readily be determined in combination with information from the system level component using tools associated with the system level model. In this way, a correlation can readily be made between the status of the system level component and the architectural state generated by the hardware description model in response to the sequence of instructions. This significantly improves the usefulness and ease of use of the models.

Hence, techniques for co-simulating the operation of a data processing apparatus are provided. The system level model comprises at least one shadow architectural state component which stores a representation of any architectural state stored by a corresponding architectural state component of the hardware description model. Any changes in architectural state stored in the corresponding architectural state component are also stored by the shadow architectural state component. Providing both an architectural state component for storing architectural state within the hardware description model and one or more shadow architectural state components for storing architectural state in the system level model ensures that the architectural state information required by the hardware description level model is still accessible within the hardware description model domain. Furthermore, by only causing the shadow architectural state component to store architectural state when architectural state within the architectural state component is updated, the number of updates between the hardware description model and the system level model can be minimized to only those which are required to provide a representation of the current state of the hardware description model. It will be appreciated that reducing the number of updates required to be communicated between the two models significantly improves the performance of these models.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

1. A method of simulating the operation of a data processing apparatus when executing a sequence of instructions, said data processing apparatus comprising a plurality of units, each of said units having associated therewith architectural state generated in response to said sequence of instructions, said method comprising the steps of:
providing a hardware description model comprising a hardware description component corresponding with at least one of said plurality of units, each hardware description component comprising a hardware characteristic component representing the hardware characteristics of that unit and an architectural state component for storing a representation of any architectural state associated with that unit generated in response to said sequence of instructions;
providing a system level model comprising a system level component corresponding with at least one other of said plurality of units, said system level model further comprising at least one shadow architectural state component for storing a representation of any architectural state stored by a corresponding architectural state component of said hardware description model;
executing said hardware description model and said system level model to simulate the operation of said data processing apparatus when executing said sequence of instructions; and
causing any changes in architectural state stored in said corresponding architectural state component to be also stored by said shadow architectural state component.

2. The method of claim 1, further comprising the step of:
providing a software debugger operable to access said system level components and said at least one shadow architectural state component.

3. The method of claim 2, further comprising the step of:
halting execution of said system level model and said hardware description model in response to a request from said software debugger.

4. The method of claim 3, further comprising the step of:
accessing said system level components and said at least one shadow architectural state component to enable details of architectural state stored by said hardware description model to be determined by said software debugger.

5. The method of claim 1, wherein said step of executing comprises co-simulating said system level model and said hardware description model.

6. The method of claim 1, wherein said step of causing comprises executing a function call from said hardware description model when said architectural state is updated.

7. The method of claim 1, wherein said step of causing comprises executing a programming language interface function call from said model hardware description when said architectural state is altered.

8. The method of claim 7, wherein said at least one shadow architectural state component stores said representation of any architectural state updated in said corresponding architectural state component of said hardware description model in response to said programming language interface function call.

9. The method of claim 1, wherein each architectural state component stores a representation of storage provided by that unit.

10. The method of claim 9, wherein said storage comprises at least one of memory regions and registers provided by that unit.

11. The method of claim 1, wherein each architectural state component stores a representation of signal levels provided by that unit.

12. The method of claim 1, wherein said system level model comprises a transaction level model.

13. The method of claim 1, wherein said system level model comprises a C programming language model.

14. The method of claim 1, wherein said hardware description model comprises an RTL model.

15. A system for simulating the operation of a data processing apparatus when executing a sequence of instructions, said data processing apparatus comprising a plurality of units, each of said units having associated therewith architectural state generated in response to said sequence of instructions, said system comprising:
a hardware description software model comprising a hardware description component corresponding with at least one of said plurality of units, each hardware description component comprising a hardware characteristic component operable to represent the hardware characteristics of that unit and an architectural state component operable to store a representation of any architectural state associated with that unit;
a system level model comprising a system level component corresponding with at least one other of said plurality of units, said system level model further comprising at least one shadow architectural state component operable to store a representation of any architectural state stored by a corresponding architectural state component of said hardware description model, said hardware description model and said system level model being operable to simulate the operation of said data processing apparatus when executing said sequence of instructions and to cause any changes in architectural state generated in response to said sequence of instructions and stored in said corresponding architectural state component to be also stored by said shadow architectural state component.

16. The system of claim 15, further comprising a software debugger operable to access said system level components and said at least one shadow architectural state component.

17. The system of claim 16, wherein said software debugger is operable to halt execution of said system level model and said hardware description model.

18. The system of claim 17, wherein said software debugger is operable to access said system level components and said at least one shadow architectural state component to enable details of architectural state stored by said hardware description model to be determined by said software debugger.

19. The system of claim 15, wherein said hardware description model and said system level model are operable to co-simulate the operation of said data processing apparatus when executing said sequence of instructions.

20. The system of claim 15, wherein said hardware description model is operable to execute a function call when said architectural state is updated.

21. The system of claim 15, wherein said hardware description model is operable to execute a programming language interface function call when said architectural state is altered.

22. The system of claim 20, wherein said at least one shadow architectural state component is operable to store said representation of any architectural state updated in said corresponding architectural state component of said hardware description model in response to said programming language interface function call.

23. The system of claim 15, wherein each architectural state component is operable to store a representation of storage provided by that unit.

24. The system of claim 22, wherein said storage comprises at least one of memory regions and registers provided by that unit.

25. The system of claim 15, wherein each architectural state component is operable to store a representation of signal levels provided by that unit.

26. The system of claim 15, wherein said system level model comprises a transaction level model.

27. The system of claim 15, wherein said system level model comprises a C programming language model.

28. The system of claim 15, wherein said hardware description model comprises an RTL model.

29. A computer program for simulating the operation of a data processing apparatus when executing a sequence of instructions, said data processing apparatus comprising a plurality of units, each of said units having associated therewith architectural state generated in response to said sequence of instructions, said computer program comprising:
a hardware description model comprising a hardware description component corresponding with at least one of said plurality of units, each hardware description component comprising a hardware characteristic component representing the hardware characteristics of that unit and an architectural state component for storing a representation of any architectural state associated with that unit generated in response to said sequence of instructions, said hardware description model being operable, when executed with a system level model comprising a system level component corresponding with at least one other of said plurality of units, to simulate the operation of said data processing apparatus when executing said sequence of instructions, said hardware description model being further operable to cause any changes in architectural state stored in said corresponding architectural state component to be also stored by a shadow architectural state component of said system level model.

30. A computer program for simulating the operation of a data processing apparatus when executing a sequence of instructions, said data processing apparatus comprising a plurality of units, each of said units having associated therewith architectural state generated in response to said sequence of instructions, said computer program comprising:
a system level model comprising a system level component corresponding with at one of said plurality of units, said system level model further comprising at least one shadow architectural state component operable to store a representation of any architectural state stored by an architectural state component of a hardware description model, said system level model being operable, when executed with said hardware description model to simulate the operation of said data processing apparatus when executing said sequence of instructions, said system level model being further operable to store in said shadow architectural state component any changes in architectural state received from said hardware description model.
